(19) United States
(12) Patent Application Publication
(10) Pub. No.: US 2008/0281026 A1
(43) Pub. Date: Nov. 13, 2008

(54) Biodegradable Thermoplastic Composition and Method for the Preparation Thereof

(76) Inventor: Gabriel Leon, Lannilis (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/628,437

(22) PCT Filed: Jun. 3, 2005
(86) PCT No.: PCT/FR2005/001363

§ 371 Date: Dec. 4, 2006

(30) Foreign Application Priority Data
Jun. 4, 2004 (FR) 0406084

(51) Int. Cl. C08K 5/103

(52) U.S. Cl. 524/317; 524/500; 524/539; 524/318

(57) ABSTRACT

The invention relates to a biodegradable thermoplastic polyester metal-, metal salt-and starch-free composition containing A) at least 50% by weight thermoplastic polyester, B) 2-20% by weight a biodegradable organic molecule having a low molecular weight, preferably ranging from 2 to 10% by weight and C) 0-30% by weight thermoplastic polymer different from the compound A.

The present invention relates to biodegradable thermoplastic polymer compositions.

Thermoplastic polymers are used in an increasingly significant way because of their low cost, their stability, their resistance towards water and oils, their resistance to degradation such as corrosion or putrefaction and their molding capacity.

However, because of the stability of these resins, the amount of synthetic resin waste products is constantly increasing, which causes a problem of pollution of soils, of the environment and another problem relating to the possible reprocessing of these products or their waste.

This is in particular the case for polyethylene, polypropylene and polystyrene, materials which are in considerable use.

Also, polyesters from the PET (polyethylene glycol terephthalate and derivatives), PBT (polybutylene glycol terephthalate and derivatives) family, are considered as non-biodegradable under current conditions. On the other hand, if they are found in comminuted form, in the form of very fine filaments or in a porous form, these polymers then become significantly more vulnerable. They may be hydrolyzed spontaneously in a moist medium or by the action of enzymes produced by microbes or microorganisms from the soil, from the environment or in composting machines.

On the other hand, it is known that polyethylene, polypropylene, polystyrene are hard to degrade under usual conditions. On the other hand, very fine fibers (from a few nanometers to one micron) are more brittle.

The degradability of a polymer is therefore a relative notion. It may be modulated.

Conversely, certain plastics or assimilated products are biodegradable. For example cellophane which is a particular physical state of cellulose, certain derivatives of cellulose including in particular cellulose diacetate, carboxymethyl cellulose or hydroxylethyl cellulose (the condensation product of cellulose with ethylene oxide), polyglycolic acid (PGA), polylactic acid (PLA), polyhydroxylbutyric acid (PHB) or further polyhydroxylvaleric acid (PHV), may be mentioned. These products often originate from plants or are obtained by fermentation. Some may be of fossil origin (petroleum derivatives). In this last class, polyethylene glycol succinate or polybutylene glycol succinate may be mentioned. Finally, some of the mentioned polymers may be obtained by both procedures. However, some of these polymers are not very stable under the usual conditions of use.

Now, it is important that the polymers which may be used for forming films, be stable under the usual conditions of use, in particular towards temperatures and this for a period agreed beforehand. Thus, it is important that these polymers exhibit relative stability to water and/or to oils, depending on the intended uses. Finally, requirements of the “food compatibility” type may play a crucial role in selecting the components.

It is clear that if a given material is required to be stable under all possible conditions, it incurs the risk of being hard to degrade. The “universal solution” would therefore only be an utopia.

The object of the present invention is to develop a family of biodegradable thermoplastic polymers capable of replacing polyethylene, polypropylene, polystyrene, at least in some of their applications, i.e. retaining the physical properties of thermoplastic compositions; the retained compositions should be able to be applied by present professional techniques without requiring the use of a specific material.

Degradable compositions based on thermoplastic polymers are already known. Thus:

U.S. Pat. No. 4,156,666 relates to the modification of polyethylene (PE), mixed ethylene-propylene polymers or mixtures of PE and polypropylene (PP) by additives such as unsaturated fatty acids or their esters and optionally a calcium-based filler such as calcium carbonate (limestone), calcium sulfate (plaster or gypsum), calcium phosphate or a magnesium-based filler: carbonate, silicate. The obtained products are easily photodegradable. However, calcium and magnesium salts are particularly abrasive for the application equipment. Further, in the absence of these salts, the composition is not very degradable. Finally, these products are not degradable in darkness.

U.S. Pat. No. 4,931,488 describes the use of an optionally chemically modified biodegradable additive of the starch (an organic molecule with high molecular weight) family. The other additives used in the composition are an iron salt of a fatty acid such as ferrous stearate and an insaturated fatty acid, therefore easily oxidizable or one of its esters. Now, starch, its derivatives, as well as cellulose has poor heat resistance. They start to break down at temperatures hardly higher than 100° C., by yellowing in a first stage and then being carbonized which may give black spots in the material, and giving off steam, which will form bubbles in the final product. Additionally, the presence of iron or other metals, or their salts, catalyzes the instability of starch and has a corrosive or abrasive effect for the equipment used in the application. The quality of the finished product incurs the risk of being uncertain or difficult to control.

International Patent Application WO-A-94/13735 is similar to the previous application. The proposed solution is to formulate a stable polymer with a biodegradable component and other additives, so as to form a synthetic biodegradable polymer. The biodegradable compounds are preferentially selected from the family of polysaccharides to which belong starch and cellulose, plus an oxidizable fatty acid or its ester and iron salts and copper salts.

The problems indicated above remain as regards metal salts and the additives of the starch family.

In addition to the patents mentioned above, a large number of other ones relate to degradable plastics. Very frequently, addition of starch or polysaccharides (organic molecules with a high molecular weight) is again found therein, as this is the case of US Patent Application 2003/0092793 or addition of metal salts, as this is the case of Patent Application WO 03/095555 A1.

These compositions therefore encounter the problems indicated above, i.e., moderate heat resistance and/or an abrasive effect on the application equipment.

Surprisingly, the inventors of the present application have discovered that certain additives of polymers, such as certain plasticizers, preservatives or other ones, i.e. organic molecules of low molecular weight, are biodegradable, thermally stable and not abrasive and that their use in certain proportions with thermoplastic polyesters imparted good biodegradability to the latter.

The present invention therefore relates to a biodegradable thermoplastic polyester composition which does not comprise any metals, metal salts, or any starch, and comprises:
A) at least 50% by weight of a thermoplastic polyester,
B) from 2% to 20% by weight of a biodegradable organic molecule of low molecular weight,
C) from 0 to 30% by weight of a thermoplastic polymer different from component A.

In the sense of the present invention, a “thermoplastic polyester composition” is understood to be any polymeric composition based on one or more thermoplastic polyesters (component A), which may contain up to 30% of a thermoplastic polymer different from component A (component C) and from 2 to 20% of a biodegradable organic molecule of low molecular weight (component B).

Advantageously, component A is selected from polyethylene glycol terephthalate, polypropylene glycol terephthalate, polybutylene glycol terephthalate, poly-1,3-propanediol terephthalate, polyethylene naphthalate, poly-omega-caprolactone or mixtures thereof.

Advantageously, component A has a T_{g} (glass transition temperature) above 40° C.

Advantageously, component C is a polymer selected from the group formed by polyurethane (PU), polyester, polystyrene (PS) and polyolefins such as polyethylene (PE), polypropylene (PP) and their copolymers, these polymers including low density polyethylenes (LDPE), high density polyethylenes (HDPE), medium density polyethylenes (MDPE), low density linear polyethylenes (LLDPE) or their mixtures.

Moreover, this component C may also be selected from the group of thermoplastic copolymers or their mixtures, such as copolymers of ethylene and vinyl acetate (EVA), in particular Evatane® marketed by Atofina, copolymers of ethylene and methyl acrylate (EMAC) such as Orevac® marketed by Atofina, butylene butyl acrylate (EBAC), polymethyl acrylate (PMA), polymethyl methacrylate (PMMA) and polyethylene oxide or polyethylene glycol (PEG) or mixtures thereof.

The component C may also be a thermoplastic polyester different from component A and selected from the group formed by polyethylene naphthalate, polyethylene glycol terephthalate, polypropylene glycol terephthalate, polybutylene glycol terephthalate, poly-1,3-propanediol terephthalate or poly-omega-caprolactone and mixtures thereof.

Advantageously, the component C is selected from the group formed by copolymers of ethylene and vinyl acetate or methyl acrylate or polyethylene naphthalate.

Advantageously, the component C is a mixture of thermoplastic polymers.

The composition according to the present invention does not contain any starch. By “starch” in the sense of the present invention, is meant any starch, whether it be natural, esterified or modified in another way, for example by means of silane.

Advantageously, the composition according to the present invention does not contain any polymer other than thermoplastic polymers.

In particular, it does not contain any polymers selected from the group formed by cellulose and its derivatives, derivatives of starch, alginates, chitin, chitosan, and polysaccharides in general.

The composition according to the present invention does not contain any proteins.

The composition according to the present invention does not comprise any metals or metals salts.

Advantageously, the composition according to the present invention does not comprise any abrasive substances. In the sense of the present invention, by “abrasive substances” is meant any substance which may cause premature wear of the equipment, such as the metal salts defined above.

The group of “naturally biodegradable” polyesters is not useful in the present invention, even if they may be added thereto, such as for example polyglycolic acid (PGA), polylactic acid (PLA), polyhydroxylbutyric acid (PHB), polyhydroxyvaleric acid (PHV), polyethylene glycol succinate or polybutylene glycol succinate. Advantageously, the composition will therefore not contain any of these polyesters.

In the sense of the present invention, by “biodegradable thermoplastic polyester composition” is meant any thermoplastic polyester composition as defined above, which disintegrates into small particles either under the action of heat, in a moist atmosphere, and/or under composting conditions. Since the thermoplastic composition also contains a naturally biodegradable substance, the small thereby formed particles are further degraded by microorganisms such as bacteria, yeasts, fungi, and/or enzymes present in the composting mixtures or in the soil. Complete degradation is thereby achieved under adequate conditions.

In the sense of the present invention, by “biodegradable organic molecule” is meant any organic molecule which may be degraded under the conditions indicated above for the biodegradable thermoplastic polyester composition.

Moreover, in the sense of the present invention, by “organic molecule of low molecular weight” is meant any molecule having a molecular weight less than 5,000, advantageously less than 2,000.

Advantageously, the biodegradable organic molecule (component B) is selected from the group formed by ethylene glycol diacetate (EGDA); glycerol triacetate and esters of polyols; diethylene glycol diacetate (DEGDA); triethylene glycol diacetate (TEGDA); polyethylene glycol diacetate (PEGDA) and analog esters derived from propylene oxide; monoesters or diesters of short chain acids and alcohols in particular selected from ethylene glycol or propylene glycol distearate, methyl stearate, glycerol tristearate, or butyl, ethyl, or methyl adipate; monoesters or diesters of a short chain acid and a fatty acid, in particular selected from dodecyl acetate, n-octyl succinate, or dodecyl succinate; mono- or di-esters of fatty acids and fatty alcohols, in particular selected from n-octyl adipate, n-dodecyl adipate, or 2-ethylhexyl adipate; fatty esters of polyethylene glycol, of polypropylene glycol or polyoxymethylene; paraffins, or mixtures thereof.

Advantageously, the component B is selected from fatty esters, triethylene glycol diacetate, dodecyl acetate, or ethylene glycol distearate. Even more advantageously, it is triethylene glycol diacetate. The amounts of the component B used are advantageously between 2 and 10% by weight, still more advantageously, between 3 and 6% by weight, yet more advantageously between 4 and 5% by weight. Even more advantageously, this is 5% by weight.

In an embodiment, the composition according to the present invention has good heat stability, advantageously at a temperature between room temperature and 300° C. At the temperature of 300° C., the composition according to the present invention is in the liquid state. In the sense of the present invention, “room temperature” means a temperature of about 20° C.

In the sense of the present invention, “good heat stability” means the absence of any change in color, in particular yellowing or blackening, or carbonization of the composition according to the present invention.

The composition according to the present invention may comprise other ingredients, such as for example plasticizers, pigments or dyes, antistatic agents, flame retarders, lubricants, nucleating agents, internal lubricants, mold release agents, or anti-shrinking agents.

The composition according to the present invention retains properties comparable to those of thermoplastic compositions, i.e. for example, they are simple to apply and have interesting mechanical properties. The composition of the present invention remains stable when it is stored and in its intended uses but it may easily be degraded after its use under the conditions indicated above.

Advantageously, the composition according to the present invention may be degraded in less than 3 months, advantageously between 1 and 2 months, in an artificial compost. In particular, for each test, the artificial compost is made in 500 ml flasks containing 50 g of microcrystalline cellulose (Alfa Aesar Avocado) suspended in 150 ml of 1M phosphate buffer, at pH 8.0, added with 1 ml of a vitamin cocktail (“Alvityl syrup”, Solvay Pharma Laboratories), 2 g of saccharose and 1 ml of an oligo-element cocktail (“Aguettant oligo-elements”, Aguettant Laboratories), 2 g of an amino acid cocktail (pancreatic casein hydrolysate, Fluka), 2 g of groundnut oil, and inoculated with a cocktail of soil microorganisms. The tested temperatures are 30, 40, 50 and 60° C. The temperature of 50° C. proved to be optimum in most cases. Below 40°, the lower the temperature, the slower is the decomposition. Finally, the compositions according to the present invention are stable at temperatures less than 0° C.

The degradation tests were carried out in the following way: the flasks contain the artificial compost and samples of the composition to be tested: a sheet of 10×15 cm per flask (i.e. above 1.25 g). They are mechanically stirred, kept in an atmosphere saturated with water and maintained at the selected temperature. It is estimated that the product is degraded when at least 90% of its weight has disappeared. The tests were always carried out on film type samples with a thickness of 50 microns±10 microns, of compositions according to the present invention.

The present invention also relates to articles comprising a composition according to the present invention, in particular made from a composition according to the present invention.

Advantageously, it is a thin film, i.e. with a thickness between 10 and 100 microns, a thick film, i.e. with a thickness between 100 microns and 1 mm, a heat-moldable film, an injected, molded or expanded article.

Finally, the present invention relates to a method for preparing a composition according to the present invention by mixing the component A with the component B, and optionally the component C at the application temperature of the most viscous polymer among the components A and C.

Mixing the polymers (solid at room temperature) and additives with low molecular weights (most often liquid additives) is generally carried out in an extruder, advantageously of the double screw type, advantageously at the temperature of about 210° C. At the outlet of the die, a strand is obtained which is cooled with water and cut into granules. These granules are carefully dried before subsequent use.

The thin films, from 10 to 100 microns, are generally obtained by the blowing-extrusion technique. An annular die extrudes a tube which is inflated with air in order to obtain the desired thickness.

The films with a thickness of the order of 1 mm, are generally obtained by calendering.

The following examples are given as an indication and not as a limitation.

### EXAMPLE 1

### Preparation of PETG Granules Containing a Liquid Additive

### TEGDA

The PETG of the investigation is PETG reference 6763 marketed by Eastman Chemicals. This product is a copolymer of terephthalic acid and ethylene glycol added with cyclohexyl-1,4-dimethanol. This product is not considered as being biodegradable.

The PETG is dried for at least 4 hours at 70° C. before any intervention. The mixture of PETG and TEGDA (triethylene glycol diacetate) is carried out by means of a double screw extruder of brand CLEXTRAL BC21 which has two feeding hoppers. TEGDA, liquid at room temperature, is introduced via a dosing pump into one of the hoppers. The speed of rotation of the screws is 300 revolutions per minute and the temperatures are in the vicinity of 220° C. At the outlet of the die, a strand with a diameter of about 3 mm is obtained, cooled with water and cut into granules with a length of about 3 mm. These granules are carefully dried for at least 24 hours at 45° C. before subsequent use.

The incorporated amount of TEGDA was 2; 3; 5; 6; 7.5 and 10% by weight of the final preparation.

The 10% TEGDA granules were slightly tacky, that is not the case for lower dosages.

### EXAMPLE 2

### Preparation of PETG Granules Containing Other Liquid Additives

The previous technique was extended without any changes to other ranges of additives such as:
various fatty esters from Cognis, in particular including “Loxiol G40”, a liquid and neutral waxy ester,
“Plaxen 185”, a paraffin marketed by “Total”,
ethylene glycol distearate,
dodecyl acetate.

Most often, these products were used at the concentration of 4% by weight.

The equipment used and the experimental conditions are identical with those used in Example 1.

### EXAMPLE 3

### Preparation of Thin PETG/TEGDA Films

Thin films from 10 to 100 microns are obtained by the blowing-extrusion technique. Sheath blowing tooling of brand COLLIN is used, fitted to a single screw extruder of brand MAPRE, having a screw with a diameter of 30 mm and a 33 D length (i.e. one meter). Eight temperature areas may be controlled: three from the hopper, one on the degassing area, three at the end of the screw and one at the die. For preparing film from granules described in Example 1 (PETG, 2 and 5% TEGDA) the following temperature profile was used (° C.): 190 (hopper), 190, 180, 170 (degassing), 180, 200, 200, 220 (die). The speed of rotation of the screw is 35 rpm. The annular die with a diameter of 50 mm extrudes a tube with a thickness of 1 mm, which is inflated with compressed air and simultaneously drawn in order to obtain the desired thickness, most often of 50 microns±10 μm.

As regards PETG added with 6, 7, 5 or 10% TEGDA, the temperature of the extruder is lower: 140 to 160° C.

PETG added with triethylene glycol diacetate (TEGDA) becomes biodegradable. TEGDA partly soluble in water and capable of migrating in the PETG matrix, is first degraded in order to leave PETG under a microporous and hydrophilic form which becomes accessible to degradation by microorganisms from the soil or the environment. It will be seen that a formulation incurs the risk of not being suitable for the long term conditioning of moist products, except for conditioning of products which should be kept at low temperature (freezer, refrigerator).

In addition, a reduction of the glass transition temperature (T_{g}) is noted, which should be taken into account. It may reach too low values to have the product compatible with the intended applications. Also, the present example, at the concentration of 10% TEGDA, the film remains tacky at room temperature and can therefore no longer be handled.

### Properties

In this example, the ideal TEGDA proportion is between 3 and 6% by weight. Under the conditions of artificial compost, as defined earlier, at 50-60° C., the degradation times vary from 1 month (6% TEGDA) to two months (3% TEGDA) for films with a thickness of 50 microns.

A pure PETG film, with a thickness of 50 microns was prepared and tested in the same degradation system. After five months of incubation, it does not show any notable sign of degradation.

### EXAMPLE 4

### Preparation of PETG Films Containing Other Liquid Additives

The technique used was extended without any changes to the other additives described in Example 2. The concentration of the additives was set to 4%.

The obtained films with a thickness of the 50 μm±10 μm, exhibited degradation times of two months, substantially under the conditions of artificial compost as defined earlier.

Nevertheless, the films containing plaxene (paraffin) exhibited a belated degradation. In addition, the quality of these films was considered as poor, as compared with the other cases.

Except for films containing plaxene which are of poor quality, the obtained films are suitable for conditioning moist products. On the other hand, they are not recommended for conditioning fatty food products except if they have the “food quality” label, as this is the case for example for ethylene glycol distearate or certain paraffinic oils of low molecular weight. Under these conditions, the stability of the film over time (if it is a film) would be closely related to the conditions of use. Migration of fatty esters is very slow at low temperature for example in the freezer or refrigerator, but increases with heat. This is a factor which will have to be taken into account in applications.

### EXAMPLE 5

### Addition of Another Polyester

To the mixture obtained in Example 1, corresponding to PETG containing 5% by weight of TEGDA, 5 to 20% by weight of polyethylene naphthalate (PEN), a thermoplastic polyester product synthesized by Teijin Dupont Films Japan Limited, is added. This mixture leads to granules which may form films.

The obtained films are still biodegradable, further the glass transition temperature rises from 10 to 50° C. depending on the proportion of PEN. They will therefore be more thermally stable.

Under the conditions of the artificial compost at 50-60° C., as defined earlier, the degradation times vary from 1 month (5% PEN) to three months (20% PEN) for films with a thickness of 50 microns. In the absence of TEGDA, the obtained films will not exhibit any sign of degradation after a period of five months under the conditions of the previous tests.

These molding- and injection-specific products may also give thin films (from 10 to 100 microns) but lack flexibility. Thick films (of the order of one mm) may be heat-molded.

In the same way as in Example 3, these products will not be suitable for long term conditioning of moist products, except for conditioning products which should be kept at low temperature (freezer, refrigerator).

### EXAMPLE 6

### A

### Preparation of PETG Granules Containing TEGDA and Polyethylene (PELD)

As in Example 1, a granule is prepared by means of a double screw extruder CLEXTRAL BC21. The PETG is introduced into a hopper, the low density polyethylene (LDPE) of reference 1008FE24 of Atofina is introduced into the other hopper, and TEGDA into the feeding well by means of a dosing pump, so as to obtain granules with the final weight composition: PETG 75, LDPE 20, TEGDA 5.

In addition, granules containing a compatibilizer were prepared: Orevac 18630 (Atofina), a random ethylene-methyl acrylate copolymer, consisting of 20% by weight of methyl acrylate. Orevac is used for providing better compatibility between various polymers including PET/PRTG, PS, PE, EVA, EVOH. In the present case, the final proportions by weight are the following: PETG 70, LDPE 20, TEGDA 5, Orevac 5.

### B

### Preparation of the Films

The films are prepared as in Example 3 with the granules defined above. The following temperature profile (° C.) was used: 180 (hopper), 180, 170, 160 (degassing), 170, 190, 190, 210 (die). The speed of rotation of the screw is 55 revolutions per minute.

The obtained films with a thickness of 50 μm±10 μm, are significantly less flexible than those obtained in Examples 3, 4, 5.

### C

### Properties

These films exhibited degradation times of substantially two months under the conditions of the article compost, as defined earlier. Presence of Orevac improves the final quality of the product. The degradation rate seemed to be a little faster for the film containing Orevac.

Films consisting of PETG and 20% PELD were prepared as comparative films. In the absence of TEGDA, the obtained films do not exhibit any sign of degradation after a period of five months under the conditions of previous tests.

### EXAMPLE 7

### A

### Preparation of PETG Granules Containing TEGDA and Evatane®

Evatane (EVA) is a random copolymer of ethylene and vinyl acetate marketed by Atofina. The Evatane 28-03 used contains 28% of vinyl acetate.

As in Example 6, a granule is prepared by means of a double screw extruder CLEXTRAL BC21. The PETG is introduced in a hopper, the EVA in the other one and TEGDA so as to obtain granules with the final weight composition:
PETG 75, EVA 20, TEGDA 5.
PETG 50, EVA 35, TEGDA 5.

### B

### Preparation of PETG, EVA, TEGDA Films

The films are prepared as in Example 3. In both cases the following temperature profile (° C.) was used: 160 (hopper), 160, 150, 140 (degassing), 150, 170, 170, 190 (die). The speed of rotation of the screw is 70 revolutions per minute.

Significantly more flexible films are then obtained. Evatane® is not spontaneously biodegradable, but when the other elements of the formulation have been strongly degraded, its degradation then becomes possible as this is seen with films processed under the previous conditions with degradation times varying from two months (10% Evatane®) to four months (30% Evatane®) for films of 50 microns. It will be noted that Evatane® poorly migrates in the macromolecular matrix, but the whole remains biodegradable. Indeed, the microorganisms of the environment may hydrolyze the acetic ester functions of Evatane®, oxidize the alcohols into ketone functions and finally cleave the macromolecular chain into many degradable fragments.

Films consisting of PETG and 20% EVA were prepared as comparative films. In the absence of TEGDA, the obtained films do not exhibit any sign of degradation after a period of five months under the conditions of the previous tests.

### EXAMPLE 8

### A

### Preparation of PETG Granules of Evatane® and of Other Products

As in Example 6, a granule is prepared by means of the double screw extruder CLEXTRAL BC21. The PETG containing 4% Loxiol or pure PETG, is introduced into a hopper, the pure EVA or a mixture of EVA granules and Orevac granules are introduced into the other one, according to the following compositions, expressed as weight:
PETG 80, EVA 20, Loxiol 4.
PETG 80, EVA 20, Loxiol 4, Orevac 5.
PETG 70, EVA 30, Loxiol 4.

### B

### Preparation of PETG, EVA, TEGDA Films

The films are prepared as in Example 3. In both cases, the following temperature profile (° C.) was used: 160 (hopper), 160, 150, 140 (degassing), 150, 170, 170, 190 (die). The speed of rotation of the screw is 70 revolutions per minute.

Significantly more flexible films are then obtained.

1. A biodegradable thermoplastic polyester composition not comprising any metals, metal salts, polymers selected from the group formed by cellulose and derivatives, derivatives of starch, alginate, chitin, chitosan, and polysaccharides in general, starch or proteins and comprising:
A) at least 50% by weight of a thermoplastic polyester not naturally biodegradable,
B) from 2% to 20% by weight of a biodegradable organic molecule with low molecular weight
c) from 0 to 30% by weight of a thermoplastic polymer not naturally biodegradable different from component A,
and having good stability at a temperature between room temperature and 300° C.

2. The composition according to claim 1, wherein the component B has a molecular weight less than 5,000.

3. The composition according to claim 1, wherein the component A is selected from polyethylene glycol terephthalate, polypropylene glycol terephthalate, polybutylene glycol teraphthalate, poly-1,3-propanediol terephthalate, polyethylene naphthalate, or poly-omega-caprolactone or mixtures thereof.

4. The composition according to claim 2, wherein the compound B is selected from the group formed by ethylene glycol diacetate (EGDA); diethylene glycol diacetate (DEGDA); triethylene glycol diacetate (TEGDA); polyethylene glycol diacetate (PEGDA); monoesters or diesters of short chain acids and alcohols; monoesters or diesters of a short chain acid and of a fatty alcohol; mono- or di-esters of fatty acids and fatty alcohols; fatty esters of polyethylene glycol, of polypropylene glycol or polyoxymethylene; paraffins or mixtures thereof.

5. The composition according to claim 1, wherein the component C is a mixture of thermoplastic polymers.

6. The composition according to claim 1, wherein it does not comprise any abrasive substances.

7. An article comprising a composition according to claim 1.

8. The article according to claim 7, wherein it is a thin film, a thick film, a heat-moldable film, an injected, molded, or expanded article.

9. A method for preparing a composition according to claim 1 by mixing component A with component B and optionally component C at the application temperature of the most viscous polymer among components A and C.

10. The composition according to claim 4, wherein the monoesters or diesters of short chain acids and alcohols are selected from ethylene glycol or propylene glycol distearate, methyl stearate, glycerol tristearate or butyl, ethyl or methyl adipate.

11. The composition according to claim 4, wherein the monoesters or diesters of a short chain acid and of a fatty alcohol are selected from dodecyl acetate, n-octyl succinate or dodecyl succinate.

12. The composition according to claim 4, wherein the mono or di-esters of fatty acids and fatty alcohols are selected from n-octyl adipate, n-dodecyl adipate or 2-ethyl-hexyl-adipate.

13. The composition according to claim 1, wherein it comprises B) from 2 to 10% by weight of a biodegradable organic molecule with low molecular weight.
